(19) United States
(12) Patent Application Publication
(10) Pub. No.: US 2015/0273639 A1
(43) Pub. Date: Oct. 1, 2015

(54) ROTARY NEST FIXTURE

(71) Applicant: NYX, Inc., Livonia, MI (US)

(72) Inventors: Baljit Singh Chandan, Windsor (CA); Vijaya S. Kanakamedala, Canton, MI (US)

(21) Appl. No.: 14/273,623

(22) Filed: May 9, 2014

Related U.S. Application Data
(60) Provisional application No. 61/971,199, filed on Mar. 27, 2014.

(51) Int. Cl. B23Q 1/66

(52) U.S. Cl. CPC B23Q 1/66

(57) ABSTRACT

A rotary nest fixture includes a fixture that has a pivot that defines an axis. The fixture includes a periphery that circumscribes the axis. The periphery includes a plurality of work faces that are each oriented toward an exclusive radial direction with respect to the axis. Nests are each removably mounted on respective ones of the work faces. The fixture is rotatable about the axis such that the nests can be selectively moved between an active position and an inactive position.

### CROSS REFERENCE TO RELATED APPLICATIONS

This application claims priority to U.S. Provisional Application No. 61/971,199, filed on Mar. 27, 2014.

### BACKGROUND

This disclosure relates to a fixture for holding or retaining a workpiece. Fixtures are known and used to hold or retain one or more workpieces while an operator performs one or more processing steps on the workpiece(s), for example. The fixture can include a nest that has a negative relief surface that corresponds to the geometry of the particular workpiece that is to be held in the fixture. Typically, the workpiece is received from prior operations or machines in a fabrication/assembly line. The assembly line may be reconfigurable to fabricate design variations of a general type of workpiece, such as design variations of an automotive interior workpiece that correspond to different vehicle models. The workpieces for each different design variation require different nests that must be changed in/out with each reconfiguration.

### SUMMARY

A rotary nest fixture according to an example of the present disclosure includes a fixture that has a pivot that defines an axis. The fixture includes a periphery circumscribing the axis. The periphery includes a plurality of work faces that are each oriented toward an exclusive radial direction with respect to the axis, and a plurality of nests. Each of the nests is removably mounted on one of the work faces. The fixture is rotatable about the axis such that the nests can be selectively moved between an active position and an inactive position.

A rotary nest fixture according to an example of the present disclosure includes a support frame and a fixture rotatably mounted on the support frame. The fixture includes a periphery circumscribing the axis. The periphery includes a plurality of work faces that are each oriented toward an exclusive radial direction with respect to the axis and a plurality of nests. Each of the nests is removably mounted on one of the work faces. The fixture is rotatable about the axis such that the nests can be selectively moved between an active position and an inactive position, and a lock that is selectively engageable such that in a locked state the fixture is prevented from rotating.

A rotary nest fixture according to an example of a present disclosure includes a fixture that has a pivot that defines an axis. The fixture includes a periphery circumscribing the axis. The periphery includes a plurality of work faces that are each oriented toward an exclusive radial direction with respect to the axis, and a plurality of nests. Each of the nests is removably mounted on one of the work faces. The fixture is rotatable about the axis. An actuator is coupled with the fixture and operable to rotate the fixture about the axis. A controller is coupled with the actuator and operable to selectively activate the actuator to rotate the fixture to move the nests between an active position and an inactive position.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates a perspective view of an example rotary nest fixture.

FIG. 2 illustrates an axial view of the rotary nest fixture of FIG. 1.

FIG. 3 illustrates another example rotary nest fixture.

FIG. 4 illustrates an example lock of a rotary nest fixture.

FIGS. 5 and 6 illustrate another example of a rotary nest fixture.

### DETAILED DESCRIPTION

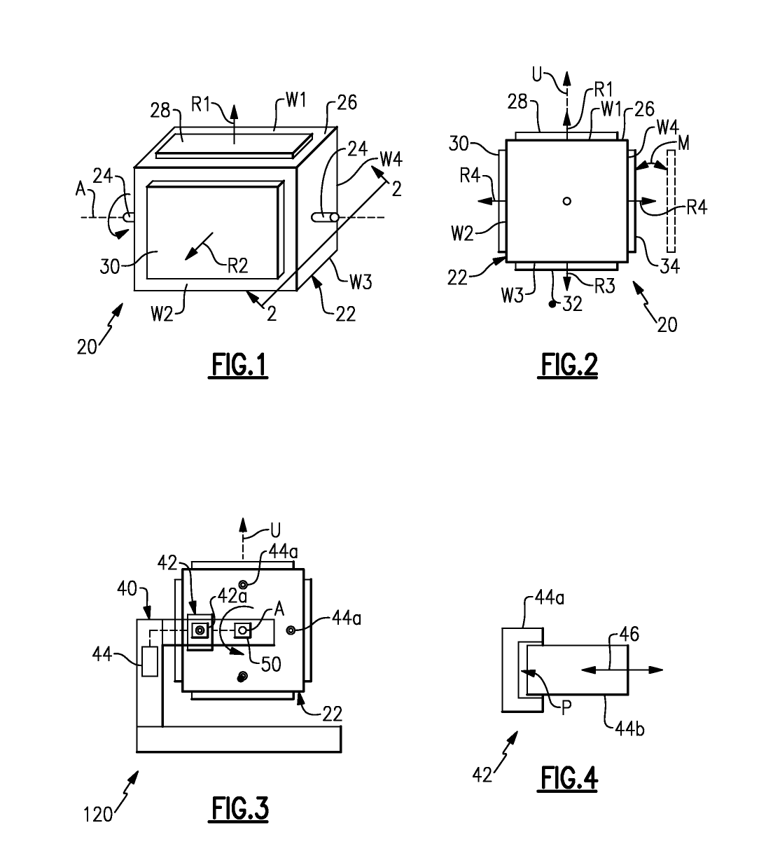

FIG. 1 illustrates selected portions of an example rotary nest fixture 20. As will be appreciated, the rotary nest fixture 20 can be used in a fabrication/assembly line that is reconfigurable to produce a variety of different workpiece designs, such as but not limited to workpieces for different vehicles or vehicle models. It is to be understood that the example rotary nest fixture 20 can be used in combination with other componentry and equipment and is not limited to the illustrated configuration.

The rotary nest fixture 20 includes a fixture 22 that has a pivot 24 that defines an axis, represented at A. The fixture 22 includes a periphery 26 that circumscribes the axis A. The periphery 26 includes a plurality of work faces, represented at W1, W2, W3, and W4. In this example, the fixture 22 is polyhedral and has six planar sides or faces. The four work faces can be equivalent in area, although in other examples the work faces can have non-equivalent areas. One or more of the work faces can also be contoured or otherwise adapted as desired for a particular functionality.

The fixture 22 will generally have four of the work faces, although fewer or additional work faces can be provided by designing the fixture 22 with a different polyhedral shape (e.g., triangular, pentagonal, hexagonal, etc. cross-sectional geometry). The end axial faces of the fixture 22 can serve additional functionality as discussed in further examples below, such as fixture support, locking, and actuation.

Referring also to FIG. 2, each of the work faces is oriented toward an exclusive radial direction with respect to the axis, represented at radial directions R1, R2, R3, and R4. That is, in this example, the fixture 22 has four functional work faces that face outwards in radial directions that are approximately 90° offset.

Each work face of the fixture 22 includes a corresponding nest 28/30/32/34. A “nest” is a contoured negative relief corresponding to the geometry of a particular workpiece. Although the nests 28/30/32/34 are shown schematically, the nests 28/30/32/34 each have a differing contoured negative relief geometry that corresponds to different geometry workpieces that are to be processed using the rotary nest fixture 20.

The nests 28/30/32/34 are removably mounted, as represented at M, to the respective work faces of the fixture 22 such that the nests 28/30/32/34 can be removed, replaced, maintained, and/or exchanged with different nests. The nests 28/30/32/34 can be affixed to the work faces using fasteners or the like.

The fixture 22 is rotatable about the axis such that the nests 28/30/32/34 can be selectively moved between an active position and an inactive position. In most examples, the active position will face vertically upwards, as represented at U in FIG. 2, such that the corresponding nest 28/30/32/34 is oriented for an operator to perform a desired operation on the workpiece held in the corresponding nest 28/30/32/34. The three other positions, including one downward-facing position and two opposed side-facing positions, are inactive positions in which the corresponding nests 28/30/32/34 are not in use. It is to be understood that the active position may be varied and that multiple active positions are also contemplated.

FIG. 3 shows another example rotary nest fixture 120. In this disclosure, like reference numerals designate like elements where appropriate and reference numerals with the addition of one-hundred or multiples thereof designate modified elements that are understood to incorporate the same features and benefits of the corresponding elements. In this example, the fixture 22 is rotatably mounted on a support frame 40 such that the fixture 22 is rotatable about the axis A on the support frame 40. In this regard, the pivot 24 can be supported on a bearing surface that permits rotation of the fixture 22. The pivot 24 can include a pin, tapered (bullet) pin, or the like, mounted on each axial side of the fixture 22 for supporting the fixture 22 on the support frame 40.

In this example, the rotary nest fixture 120 also includes a lock 42 that is selectively engageable such that in a locked state the fixture 22 is prevented from rotating. The lock 42 can be a manual lock, and automated lock, or a semi-automated lock. If automated or semi-automated, the lock 42 can include a lock actuator 42a and a controller 44 can be connected with the lock actuator 42a to control the operation thereof with respect to the locked state. For example, the lock actuator can include a motor, solenoid, or the like.

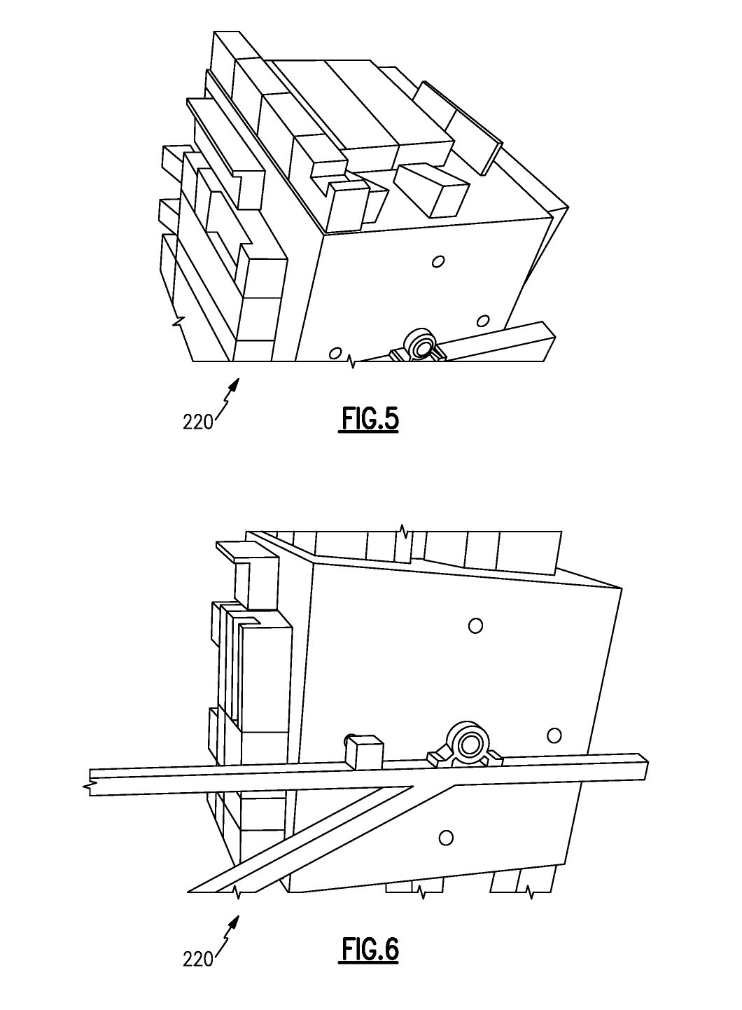

Referring also to FIG. 4, the lock 42 can include first and second lock members 44a, 44b. In this example, the lock member 44a is a pin receiver that has a pocket P, and the lock member 44b is a lock pin. The lock pin can be axially actuated, as represented at 46, to move into and out of the pocket of the pin receiver. The lock 42 is in the locked state when the lock pin is moved into the pocket of the pin receiver.

The first lock member 44a can be mounted on the fixture 22 or the frame support 40 and the second lock member 44b can be mounted on the other of the fixture or the frame support 40. In a further example, the fixture 22 includes a plurality of the pin receivers mounted on an axial face and circumferentially-spaced around the axis A. The frame support 40 includes a single lock pin. The fixture 22 can be rotated until one of the pin receivers aligns with the lock pin. The lock pin can then be moved into the pocket of the pin receiver to prevent rotation of the fixture 22 such that a selected one of the nests 28/30/32/34 is in the active position. In this regard, an operator can rapidly change configurations by rotating the fixture 22 between selected ones of the nests 28/30/32/34 without having to remove a nest, mount a different nest, and take steps to ensure that the newly mounted nest is properly mounted and aligned. Additionally, less space is needed for nest storage and the ease of reconfiguration reduces risk of nest damage.

In a further example, the rotary nest fixture 120 can also include an actuator 50 that is coupled with the fixture 22 to control rotation. The actuator 50 can also be connected with the controller 44, which can selectively activate the actuator 50 as well as the lock 42 to control operation of the rotary nest fixture 120 in an automated fashion. In this regard, the controller 44 can include hardware (e.g., a microprocessor, display, operation interface, etc.), software, or combinations thereof.

FIGS. 5 and 6 illustrate a further example of a rotary nest fixture 220, showing several nests mounted on the corresponding work faces.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A rotary nest fixture comprising:
a fixture including a pivot defining an axis, the fixture including a periphery circumscribing the axis, the periphery including a plurality of work faces that are each oriented toward an exclusive radial direction with respect to the axis; and
a plurality of nests, each of the nests being removably mounted on one of the work faces, the fixture being rotatable about the axis such that the nests can be selectively moved between an active position and an inactive position.

2. The rotary nest fixture as recited in claim 1, wherein the periphery of the fixture includes at least two of the work faces.

3. The rotary nest fixture as recited in claim 1, wherein the active position faces vertically upwards.

4. The rotary nest fixture as recited in claim 1, further comprising a lock that is selectively engageable such that in a locked state the fixture is prevented from rotating.

5. The rotary nest fixture as recited in claim 1, further comprising an actuator coupled with the fixture and operable to selectively rotate the fixture between the active position and the inactive position.

6. The rotary nest fixture as recited in claim 5, further comprising a controller in communication with the actuator and operable to control the operation of the actuator.

7. The rotary nest fixture as recited in claim 1, wherein the fixture is symmetric about the axis.

8. The rotary nest fixture as recited in claim 1, wherein each of the nests has a different geometry than the other nests.

9. A rotary nest fixture comprising:
a support frame;
a fixture rotatably mounted on the support frame, the fixture including a periphery circumscribing the axis, the periphery including a plurality of work faces that are each oriented toward an exclusive radial direction with respect to the axis;
a plurality of nests, each of the nests being removably mounted on one of the work faces, the fixture being rotatable about the axis such that the nests can be selectively moved between an active position and an inactive position; and
a lock that is selectively engageable such that in a locked state the fixture is prevented from rotating.

10. The rotary nest fixture as recited in claim 9, wherein the lock includes a lock pin and at least one pin receiver, the lock pin being receivable into a pocket of the at least one pin receiver in the locked state, the lock pin being mounted on either the fixture or the support frame and the at least one pin receiver being mounted on the other of the fixture or the support frame.

11. The rotary nest fixture as recited in claim 10, wherein the fixture includes a plurality of the pin receivers circumferentially-spaced around the axis.

12. The rotary nest fixture as recited in claim 10, wherein the lock includes a lock actuator operable to selectively move the lock pin with respect to the locked state.

13. The rotary nest fixture as recited in claim 9, wherein a rotary location of the lock is different from the rotary location of the active position.

14. The rotary nest fixture as recited in claim 9, wherein the periphery of the fixture includes at least two of the work faces.

15. The rotary nest fixture as recited in claim 9, wherein each of the nests has a different geometry than the other nests.

16. A rotary nest fixture comprising:
a fixture including a pivot defining an axis, the fixture including a periphery circumscribing the axis, the periphery including a plurality of work faces that are each oriented toward an exclusive radial direction with respect to the axis;
a plurality of nests, each of the nests being removably mounted on one of the work faces, the fixture being rotatable about the axis;
an actuator coupled with the fixture and operable to rotate the fixture about the axis; and
a controller coupled with the actuator and operable to selectively activate the actuator to rotate the fixture to move the nests between an active position and an inactive position.

17. The rotary nest fixture as recited in claim 16, further comprising a lock that is selectively engageable such that in a locked state the fixture is prevented from rotating.

18. The rotary nest fixture as recited in claim 17, wherein the lock includes a lock actuator operable to selectively move the lock pin with respect to the locked state.

19. The rotary nest fixture as recited in claim 18, wherein the controller is coupled with the lock actuator and operable to move a lock pin of the lock with respect to the locked state.
